(19) United States
(12) Patent Application Publication
(10) Pub. No.: US 2018/0084275 A1
(43) Pub. Date: Mar. 22, 2018

(54) CALCULATION DEVICE, CALCULATION METHOD, AND PROGRAM

(71) Applicant: OLYMPUS CORPORATION, Tokyo (JP)

(72) Inventor: Takashi Yanada, Tokyo (JP)

(73) Assignee: OLYMPUS CORPORATION, Tokyo (JP)

(21) Appl. No.: 15/824,147

(22) Filed: Nov. 28, 2017

Related U.S. Application Data
(63) Continuation of application No. PCT/JP2016/065759, filed on May 27, 2016.

(30) Foreign Application Priority Data
Jun. 3, 2015 (JP) 2015-113210

(51) Int. Cl. H04N 19/557; H04N 19/43; H04N 19/176; H04N 19/137; H04N 19/127

(52) U.S. Cl. CPC H04N 19/557; H04N 19/43; H04N 19/127; H04N 19/137; H04N 19/176

(57) ABSTRACT

A calculation device of the present invention is a calculation device includes a standard block data storage unit that stores data of the standard block, a reference block data storage unit that stores data of the reference block, a plurality of correlation calculation units that simultaneously calculate correlation values at a plurality of different positions, and a sorting unit that sorts the plurality of correlation values calculated by the correlation calculation unit in a descending order of correlation, and holds a result of the sorting, and the calculation device compares correlation threshold values respectively input to the plurality of correlation calculation units with the plurality of correlation values calculated by the plurality of correlation calculation units, and performs a correlation calculation stop process of stopping an operation of the correlation calculation unit when the correlation value has a lower correlation than the correlation threshold value.

The present invention relates to a calculation device, a calculation method, and a program. This application is a continuation application based on a PCT International Application No. PCT/JP2016/065759, filed on May 27, 2016, whose priority is claimed on Japanese Patent Application No. 2015-113210, filed Jun. 3, 2015. Both of the content of the PCT International Application and the Japanese Application are incorporated herein by reference.

### FIELD OF THE INVENTION

### Description of Related Art

In the field of shake correction of a moving image or compression of a moving image, a method of using a result of calculating a motion vector is known. A method of using a block-matching method is widely known as a method of calculating a motion vector. The block-matching method is a method of dividing two images to be compared into a plurality of areas and calculating a correlation value between the two images for each divided area. A motion vector is calculated on the basis of the correlation value acquired from a result of the calculation.

A motion vector detection device using such a block-matching method is proposed in, for example, Japanese Patent No. 4547321.

### SUMMARY OF THE INVENTION

A calculation device according to a first aspect of the present invention is a calculation device divides a standard frame into a plurality of standard blocks, sets a reference block corresponding to the standard frame in a reference frame, and performs correlation calculation between the standard block and the reference block, the calculation device comprising: a standard block data storage unit that stores data of the standard block; a reference block data storage unit that stores data of the reference block; a plurality of correlation calculation units that receive respective predetermined correlation threshold values and simultaneously calculate correlation values at a plurality of different positions using data of the standard block and data of the reference block; and a sorting unit that sorts the plurality of correlation values calculated by the correlation calculation unit in a descending order of correlation, holds a result of the sorting, and outputs the correlation threshold values, wherein the calculation device compares the respective input correlation threshold values with the plurality of correlation values calculated by the plurality of correlation calculation units, and performs a correlation calculation stop process of stopping an operation of the correlation calculation unit when the correlation value has a lower correlation than the correlation threshold value.

According to a second aspect of the present invention, in the calculation device according to the first aspect, the correlation threshold value is a correlation value having the highest correlation among the correlation values after sorting held in the sorting unit.

According to a third aspect of the present invention, in the calculation device according to the first aspect, the correlation calculation stop process is a process of stopping an operation of the correlation calculation unit by stopping an operation clock of the correlation calculation unit.

According to a fourth aspect of the present invention, the calculation device according to the first aspect, the correlation calculation stop process is a process of stopping an operation of the correlation calculation unit by setting one of pieces of data to be input to the correlation calculation unit to a maximum value and the other to a minimum value.

According to a fifth aspect of the present invention, in the calculation device according to the first aspect, the correlation calculation stop process is a process that ends when correlation calculation between the next standard block and the reference block is started.

A calculation method according to an sixth aspect of the present invention is a calculation method of dividing a standard frame into a plurality of standard blocks, setting a reference block corresponding to the standard frame in a reference frame, and performing correlation calculation between the standard block and the reference block, the calculation method comprising: a standard block data storage step of storing data of the standard block; a reference block data storage step of storing data of the reference block; a plurality of correlation calculation steps of receiving respective predetermined correlation threshold values and simultaneously calculating correlation values at a plurality of different positions using data of the standard block and data of the reference block; and a sorting step of sorting the plurality of correlation values calculated in the correlation calculation step in a descending order of correlation, holding a result of the sorting, and outputting the correlation threshold values, wherein the method includes a correlation calculation stop step of comparing the respective input correlation threshold values with the plurality of correlation values respectively calculated in the plurality of correlation calculation steps, and stopping an operation in the correlation calculation step when the correlation value has a lower correlation than the correlation threshold value.

A non-transitory computer-readable computer medium storing a program according to a seventh aspect of the present invention causes a computer to divide a standard frame into a plurality of standard blocks, set a reference block corresponding to the standard frame in a reference frame, and perform correlation calculation between the standard block and the reference block, the program causing the computer to execute: a standard block data storage step of storing data of the standard block; a reference block data storage step of storing data of the reference block; a plurality of correlation calculation steps of receiving respective predetermined correlation threshold values and simultaneously calculating correlation values at a plurality of different positions using data of the standard block and data of the reference block; a sorting step of sorting the plurality of correlation values calculated in the correlation calculation step in a descending order of correlation, holding a result of the sorting, and outputting the correlation threshold values; and a correlation calculation stop step of comparing the respective input correlation threshold values with the plurality of correlation values respectively calculated in the plurality of correlation calculation steps, and stopping an operation in the correlation calculation step when the correlation value has a lower correlation than the correlation threshold value.

### BRIEF DESCRIPTION OF THE DRAWINGS

FIG. 1 is a schematic diagram illustrating an example of correlation calculation between two images using a block-matching method.

FIG. 2A is a schematic diagram illustrating an example of a calculation amount of correlation calculation in the block-matching method.

FIG. 2B is a schematic diagram illustrating an example of the calculation amount of the correlation calculation in the block-matching method.

FIG. 3 is a schematic diagram illustrating an example of correlation calculation in the calculation device according to the first embodiment of the present invention.

FIG. 4 is a schematic diagram illustrating an example of correlation calculation in the calculation device according to the first embodiment of the present invention.

FIG. 5 is a schematic diagram illustrating an example of correlation calculation in the calculation device according to the first embodiment of the present invention.

FIG. 6 is a diagram illustrating an example of a configuration of the calculation device according to the first embodiment of the present invention.

FIG. 7 is a timing chart illustrating an example of a timing at which luminance value data is input to an absolute difference value calculation unit 301 of a calculation device 1 according to the first embodiment of the present invention.

FIG. 8 is a diagram illustrating an example of a configuration of a sorting unit 40 of the calculation device 1 according to the first embodiment of the present invention.

FIG. 9 is a schematic diagram illustrating an example of correlation calculation in the calculation device 1 according to the first embodiment of the present invention.

FIG. 10 is a schematic diagram illustrating an example of correlation calculation in the calculation device 1 according to the first embodiment of the present invention.

FIG. 11 is a schematic diagram illustrating an example of correlation calculation in the calculation device 1 according to the first embodiment of the present invention.

FIG. 12 is a diagram illustrating an example of a configuration of a correlation calculation unit 30 and a sorting unit 40 of the calculation device 1 according to the first embodiment of the present invention.

FIG. 13 is a diagram illustrating an example of a calculation stop operation of a correlation calculation unit 30 of the calculation device 1 according to the first embodiment of the present invention.

FIG. 14 is a flowchart illustrating an example of an operation of the calculation device 1 according to the first embodiment of the present invention.

FIG. 15 is a diagram illustrating an example of a calculation stop operation of a correlation calculation unit 30 of a calculation device 1 according to a second embodiment of the present invention.

FIG. 16 is a diagram illustrating an example of a calculation stop operation of a correlation calculation unit 30 of a calculation device 1 according to a third embodiment of the present invention.

### DETAILED DESCRIPTION OF THE INVENTION

First, a simple principle of a block-matching method will be described with reference to the drawings.

The block-matching method is a method of dividing at least one of two images to be compared into a plurality of areas and calculating a correlation value between the two images for each area. Hereinafter, one of the two images to be compared is referred to as a standard frame, and the other is referred to as a reference frame.

In the block-matching method, correlation calculation is performed between a specific area in a standard frame (a standard block) and a specific area in a reference frame (a reference block). The standard block and the reference block have the same size of area.

Generally, in the correlation calculation, a calculation method such as Sum of Absolute Difference (SAD), Sum of Squared Difference (SSD), Normalized Cross-Correlation (NCC), or Zero-mean Normalized Cross-Correlation (ZNCC) is used.

Using the block-matching method, it is possible to specify (a position of) the standard block having the highest correlation with the reference block or to detect a motion vector.

Hereinafter, for simplification of description, the size of the area of the reference frame in this example is assumed to be a size of area smaller than that of the standard frame. Further, the reference frame and the reference block are assumed to have the same size of area. That is, the entire reference frame is assumed to be one reference block.

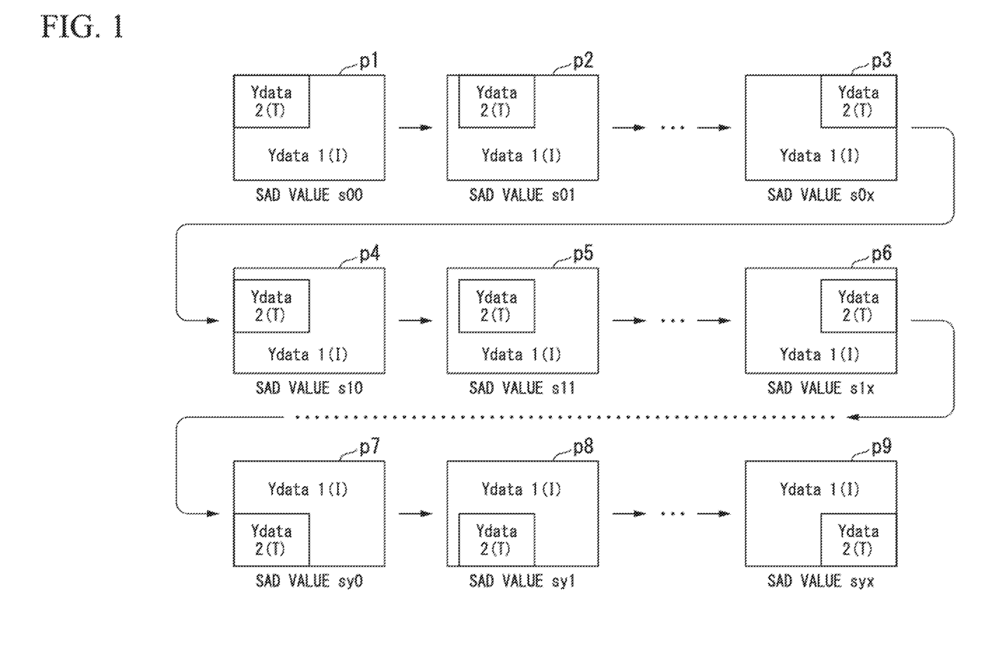

FIG. 1 is a schematic diagram illustrating an example of correlation calculation between two images using the block-matching method.

When the correlation calculation is performed, for example, a reference block (a reference frame Ydata 2(T)) is set for one standard block (here, a top leftmost standard block as illustrated in an image p1 in FIG. 1) in the standard frame Ydata 1(I) indicating a standard frame. A correlation value between the standard block and the reference block is calculated. In this example, the correlation value to be obtained is assumed to be a SAD value. Further, the SAD value in this example is calculated by summing absolute values of differences in luminance value between respective pixels of the standard block data and the reference block data. A smaller SAD value indicates a higher correlation between the image included in the standard block and the image included in the reference block.

A SAD value between the next standard block that is an area shifted by one pixel in a horizontal direction from the standard block within the standard frame Ydata 1(I) and the reference block is calculated (an image p2 in FIG. 1). Then, similarly, a SAD value between the standard block shifted by one pixel to the right in the horizontal direction and the reference block is sequentially calculated. After a standard block at a right end within the standard frame Ydata 1(I) is reached (an image p3 in FIG. 1), a SAD value between a standard block at a left end, which is shifted by one pixel downward in a vertical direction, within the standard frame Ydata 1(I) and the reference block is calculated (an image p4 in FIG. 1). Then, similarly, a SAD value between a standard block shifted by one pixel to the right in the horizontal direction and the reference block is sequentially calculated. Through repetition of this process, the SAD value between a bottom rightmost standard block within the standard frame Ydata 1(I) and the reference block is calculated, and the calculation of the SAD values between all of the standard blocks and the reference blocks is completed (an image p9 in FIG. 1).

Each SAD value calculated by the above process is subjected to various types of statistical processing depending on use, and is used. For example, a minimum value among the calculated SAD values is obtained in order to specify the standard block most similar to the reference block, or the calculated SAD values are sorted in an ascending order in order to use the SAD values as evaluation values. Further, each calculated SAD value may be used to calculate a motion vector.

As described above, in the block-matching method, when an area of the image for which the SAD value is calculated becomes larger, the amount of calculation increases. Therefore, a calculation circuit that calculates the SAD values operates continuously at all times, and accordingly, power consumption in the calculation circuit increases.

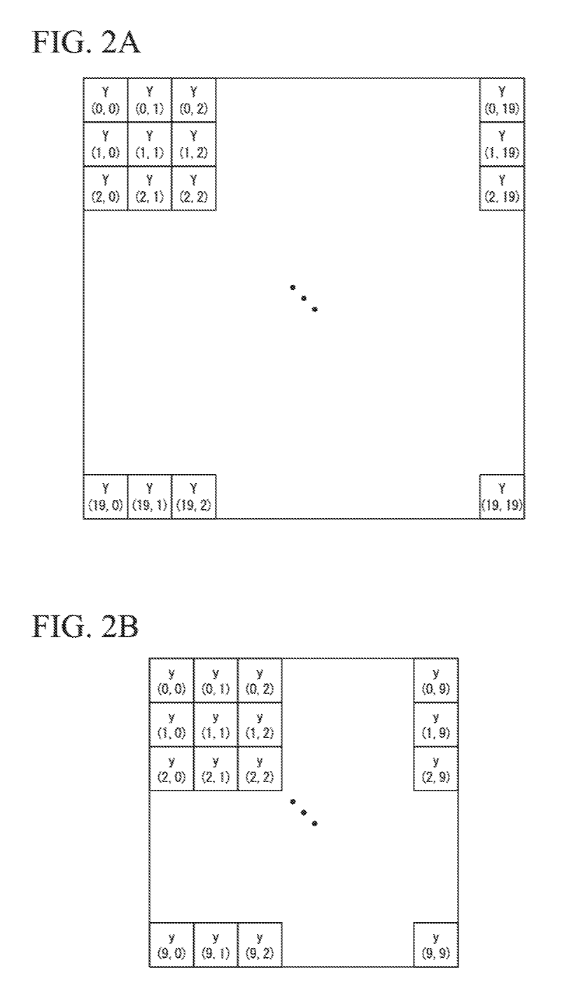

FIGS. 2A and 2B are schematic diagrams illustrating an example of the calculation amount of the correlation calculation in the block-matching method.

For example, the standard frame Ydata 1(I) is assumed to be an image of 400 pixels having 20 pixels in the horizontal direction and 20 pixels in the vertical direction (FIG. 2A). Further, for example, the reference frame Ydata 2(T) is assumed to be an image having 10 pixels in the horizontal direction and 10 pixels in the vertical direction (FIG. 2B). That is, the reference block and each standard block are also assumed to be images having 10 pixels in the horizontal direction and 10 pixels in the vertical direction.

In this case, a SAD calculation process of calculating the SAD value between one standard block and a reference block includes 100 (=10×10) luminance value subtraction processes, 100 (=10×10) absolute difference value calculation processes, and 99 (=100-1) absolute difference value addition processes.

Since a total of 121 (=11×11) standard blocks are included in the standard frame, it is necessary to perform the SAD calculation process 121 times in order to calculate the SAD value between each standard block included in the standard frame and the reference block.

The above is an example of a case in which the standard frame Ydata 1(I) includes 400 pixels. However, for example, images captured by a recent compact digital camera include images having more than 15 million pixels, and an enormous amount of calculation is actually repeated.

### First Embodiment

Hereinafter, a first embodiment will be described with reference to the drawings.

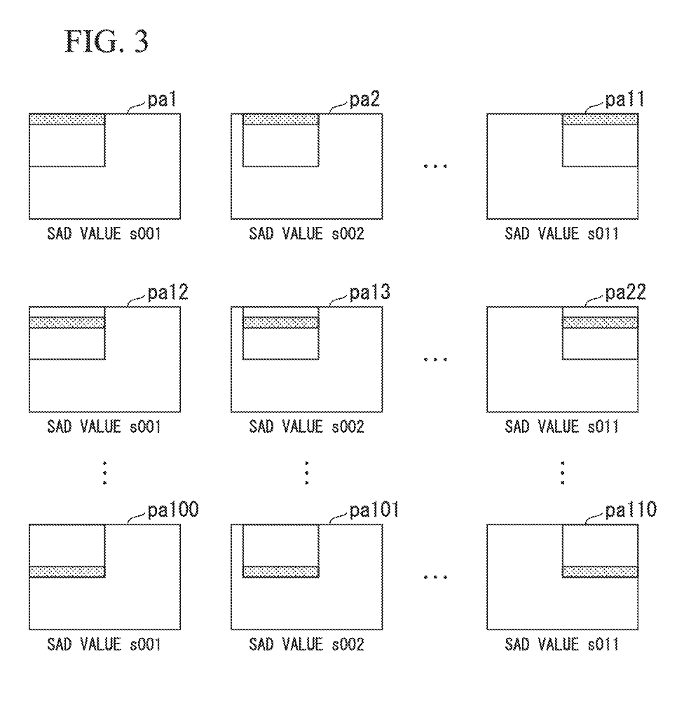

FIGS. 3, 4, and 5 are schematic diagrams illustrating an example of correlation calculation in a calculation device according to the first embodiment of the present invention.

A calculation device 1 that will be illustrated below is a calculation device that calculates the SAD values between the standard frame Ydata 1(I), which is data indicating an image having 20 pixels in the horizontal direction and 20 pixels in the vertical direction, as illustrated in FIG. 2A, and the reference frame Ydata 2(I), which is data indicating an image having 10 pixels in the horizontal direction and 10 pixels in the vertical direction, as illustrated in FIG. 2B.

The calculation device 1 according to the first embodiment includes a plurality of calculation circuits for calculating the SAD values in order to ensure a high operation speed. For example, the calculation device 1 according to the first embodiment includes 110 calculation circuits (hereinafter referred to as absolute difference value calculation circuits) capable of calculating the absolute value of a difference between the luminance values of pixels (hereinafter referred to as absolute difference value). Therefore, the calculation device 1 can simultaneously calculate the absolute difference values for 110 pixels.

An image pa1 of FIG. 3 indicates that a top leftmost standard block of the standard frame Ydata 1(I) is set as an area for comparison with the reference block. The calculation device according to the first embodiment calculates an absolute difference value for the pixel between the standard block and the reference block for each pixel of the uppermost line including 10 pixels of the standard block. The calculation device sums the calculated absolute difference values (for a total of 10 pixels) to calculate the SAD value (hereinafter, this addition process is referred to as horizontal addition).

In order to simultaneously perform the calculations of the absolute difference values for 10 pixels shown in the image pa1 of FIG. 3 at one time, ten absolute difference value calculation circuits are required. Further, 110 absolute difference value calculation circuits are required in order for the calculation device 1 according to the first embodiment to simultaneously perform calculations of the absolute difference values for 110 (=10×11) pixels shown from the image pa1 of FIG. 3 to the image pa11 of FIG. 3 at one time.

As described above, the calculation device 1 according to the first embodiment includes 110 absolute difference value calculation circuits, and can simultaneously perform 110 calculations of the absolute difference values for the pixels included in one line (row) in the standard frame Ydata 1(I) at one time.

Accordingly, the calculation device 1 can perform calculation of each absolute difference value and horizontal addition from the image pa1 in FIG. 3 to the image pa11 in FIG. 3 in one calculation, and can calculate 11 SAD values in one calculation.

The calculation device according to the first embodiment then simultaneously performs 110 calculations of the absolute difference values of the second line from the top of the standard frame Ydata 1(I) at one time. That is, the calculation device according to the first embodiment performs calculations of the absolute difference values for 110 pixels shown in the images pa12 to pa22 in FIG. 3, and 11 horizontal additions simultaneously in one process.

The calculation device adds the SAD value calculated through horizontal addition from the image pa12 in FIG. 3 to the image pa22 in FIG. 3 to the SAD value calculated from the image pa1 in FIG. 3 to the image pa11 in FIG. 3 (hereinafter, this addition process will be referred to as vertical addition).

Further, by repeating the above process, the calculation device according to the first embodiment can perform the SAD calculation from the image pa1 in FIG. 3 to the image pa110 in FIG. 3 in a total of ten processing times. Accordingly, the calculation device according to the first embodiment can perform the SAD calculation between the reference block and the 11 standard blocks located at the uppermost end in the standard frame Ydata 1(I) at a total of 10 processing times.

Thus, the calculation device can calculate the SAD values (SAD value s001, SAD value s002, . . . , SAD value s011) between the reference block and the 11 standard blocks located at the uppermost end in the standard frame Ydata 1(I).

Here, the calculation device according to the first embodiment sorts the 11 calculated SAD values (SAD value s001, SAD value s002, . . . , SAD value s011) in an ascending order (that is, in a descending order of correlation) using the sorting unit 40 to be described below.

The sorting unit 40 holds, for example, only the top ten SAD values above the smallest value among the above SAD values.

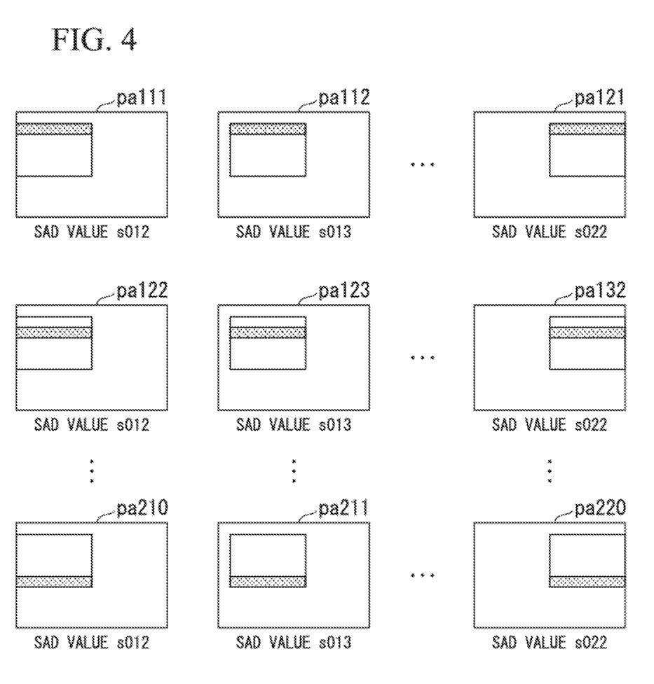

Then, similarly, the calculation device according to the first embodiment performs the SAD calculations between the reference block and the 11 standard blocks that are in an area shifted by one pixel downward in the vertical direction within the standard frame Ydata 1(I) 11 in a total of ten processing times (from the image pa11 in FIG. 4 to the image pa220 in FIG. 4).

Thus, the calculation device can calculate the SAD values (SAD value s012, SAD value S013, . . . , SAD value s022) between the reference block and the 11 standard blocks that are in an area shifted by one pixel downward in the vertical direction within the standard frame Ydata 1(I).

Here, the calculation device 1 according to the first embodiment sorts the SAD values including the 10 SAD values previously calculated and held in the sorting unit, in addition to the 11 calculated SAD values (SAD value s012, SAD value s013, . . . , SAD value s022) in an ascending order of values (that is, in a descending order of correlation) using the sorting unit 40, which will be described below.

The sorting unit 40 holds, for example, only the top ten SAD values above the smallest value among the above values.

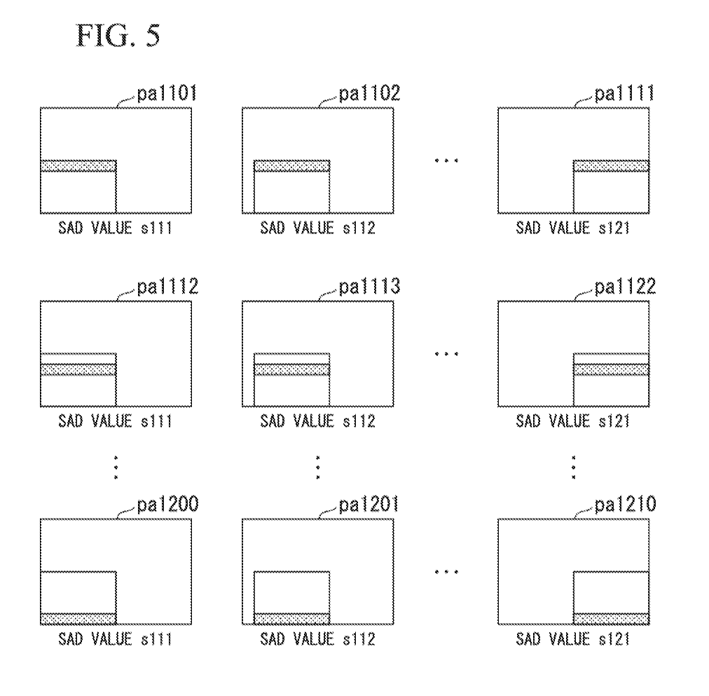

The calculation device 1 according to the first embodiment ends the SAD calculation between the reference block and all of 121 standard blocks in the standard frame Ydata 1(I) by performing the SAD calculation (from an image pa1101 in FIG. 5 to an image pa1210 in FIG. 5) between the reference block and 11 standard blocks located in the lowest end of the standard frame Ydata 1(I).

Accordingly, the calculation device 1 according to the first embodiment can perform the SAD calculation between the reference block and all of the 121 standard blocks in the standard frame Ydata 1(I) at a total of 110 (10×11) processing times.

As described above, the calculation device 1 can specify, for example, the top ten SAD values from a smaller value (that is, a higher correlation) among the SAD values (SAD value s001, SAD value s002, . . . , SAD value s121) between all the 121 standard blocks within the standard frame Ydata 1(I) and the reference block. That is, the calculation device 1 can specify the standard block having a highest correlation with the reference block among the 121 standard blocks in the standard frame Ydata 1(I).

(Basic Configuration of the Calculation Device 1)

Next, a basic configuration of the calculation device 1 will be described with reference to the drawings.

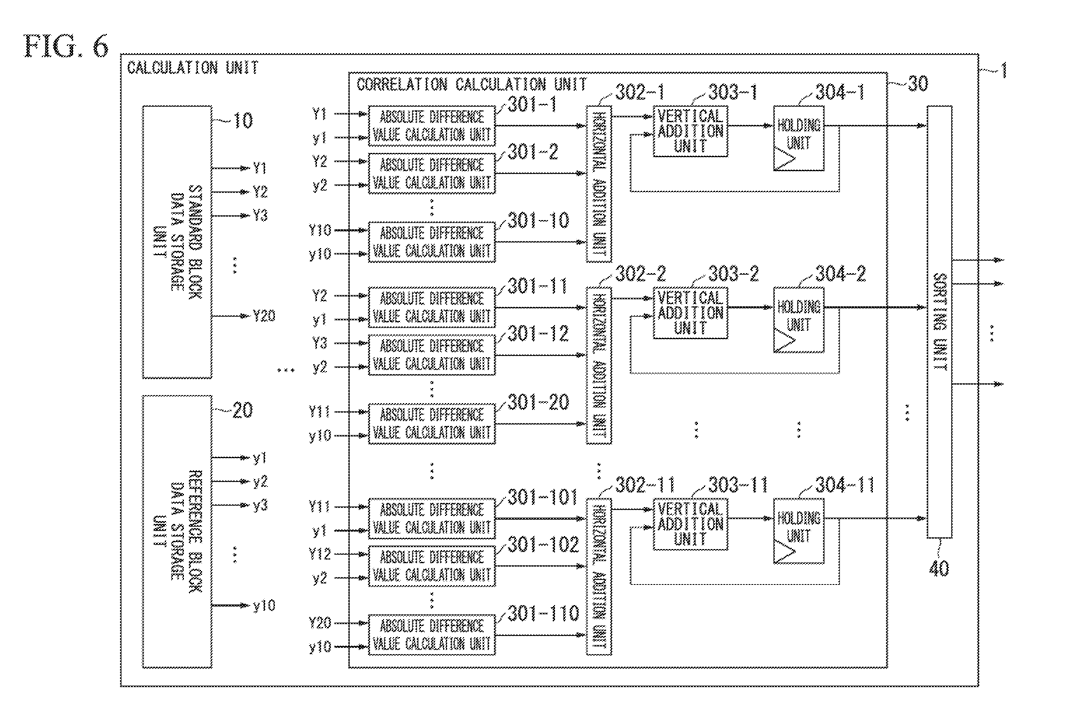

FIG. 6 is a diagram illustrating an example of a configuration of the calculation device 1 according to the first embodiment of the present invention.

As illustrated, the calculation device 1 includes a standard block data storage unit 10, a reference block data storage unit 20, a correlation calculation unit 30, and a sorting unit 40.

The standard block data storage unit 10 stores data of each standard block divided from standard frame data Y1(I). The standard block data storage unit 10 includes, for example, a dynamic random access memory (DRAM), a static random access memory (SRAM), or a synchronous DRAM (SDRAM).

The reference block data storage unit 20 stores data of each reference block divided from reference frame data Y2(T). The reference block data storage unit 20 includes, for example, a DRAM, an SRAM, or an SDRAM.

The correlation calculation unit 30 performs correlation calculation between the data of the standard block acquired from the standard block data storage unit 10 and the data of the reference block acquired from the reference block data storage unit 20. The calculation device 1 illustrated in FIG. 6 indicates a circuit that performs SAD calculation. In this case, the correlation calculation unit 30 outputs a SAD value obtained by calculating an absolute value (absolute difference value) of a difference between luminance values of pixels included in each standard block and the reference block and obtaining a sum of the absolute difference values for the respective standard blocks to the sorting unit 40.

A configuration of the correlation calculation unit 30 will be described in detail below.

The sorting unit 40 sorts the SAD values of the standard blocks acquired from the correlation calculation unit 30 in an ascending order of values (in a descending order of correlation). The sorting unit 40 stores the SAD values of predetermined number of cases (for example, the top ten cases) among the sorted SAD values.

Each time a SAD value is acquired from the correlation calculation unit 30, the sorting unit 40 sorts the acquired SAD values, including the already stored SAD values, in an ascending order of values (a descending order of correlation). The sorting unit 40 specifies the SAD values for a predetermined number of cases (for example, the top ten cases) among the sorted SAD values, and overwrites and updates the stored SAD values with the specified SAD values.

(Configuration of Correlation Calculation Unit)

Next, a configuration of the correlation calculation unit 30 will be described with reference to FIG. 6.

As illustrated, the correlation calculation unit 30 includes 110 absolute difference value calculation units 301 (301-1, 301-2, . . . , 301-110), 11 horizontal addition units 302 (302-1, 302-2, . . . , 302-11), 11 vertical addition units 303 (303-1, 303-2, . . . , 303-11), and 11 holding units 304 (304-1, 304-2, . . . , 304-11).

The absolute difference value calculation units 301 (301-1, 301-2, . . . , 301-110) acquire data (Y1 to Y20 in FIG. 6) indicating the luminance value of one pixel in the standard block from the standard block data storage unit 10 and data (y1 to y10 in FIG. 6) indicating the luminance value of one pixel in the reference block from the reference block data storage unit 20. The absolute difference value calculation units 301 (301-1, 301-2, . . . , 301-110) calculate the absolute difference value of the two acquired luminance values and output a result of the calculation to the horizontal addition units 302 (302-1, 302-2, . . . , 302-11).

For example, data input from the absolute difference value calculation unit 301-1 to the absolute difference value calculation unit 301-10 is data for one line when the standard block is at the leftmost end of the standard frame, like in an image pa1 in FIG. 3, an image pa12 in FIG. 3, an image pa100 in FIG. 3, an image pa111 in FIG. 4, an image pa122 in FIG. 4, an image pa210 in FIG. 4, an image pa1101 in FIG. 5, an image pa1112 in FIG. 5, an image pa1200 in FIG. 5, or the like.

Similarly, for example, data input from the absolute difference value calculation unit 301-11 to the absolute difference value calculation unit 301-20 is data for one line when the standard block is at a position shifted to the right by one pixel from a left end in the standard frame, like in an image pa2 in FIG. 3, an image pa13 in FIG. 3, an image Pa101 in FIG. 3, an image Pa112 in FIG. 4, an image Pa123 in FIG. 4, an image pa211 in FIG. 4, an image Pa1102 in FIG. 5, an image Pa1113 in FIG. 5, an image pa1201 in FIG. 5, or the like.

Similarly, for example, data input from the absolute difference value calculation unit 301-11 to the absolute difference value calculation unit 301-20 is data for one line when the standard block is at the rightmost end of the standard frame, like in an image pa11 in FIG. 3, an image pa22 in FIG. 3, an image pa110 in FIG. 3, an image pa121 in FIG. 4, an image pa132 in FIG. 4, an image pa220 in FIG. 4, an image pa1111 in FIG. 5, an image pa1122 in FIG. 5, an image pa1201 in FIG. 5, or the like.

Thus, the correlation calculation unit 30 can perform the calculation of the absolute difference values for one line of the standard frame at one time by performing calculation of 110 absolute difference values at one time using the 110 absolute difference value calculation units 301 (301-1, 301-2, . . . , 301-110).

The horizontal addition units 302 (302-1, 302-2, . . . , 302-11) calculate SAD values obtained by summing the 10 absolute difference values respectively acquired from the 10 absolute difference value calculation units 301, and output the SAD values to the vertical addition units 303 (303-1, 303-2, . . . , 303-11).

For example, the horizontal addition unit 302-1 sums the absolute difference values output by the absolute difference value calculation units 301 from the absolute difference value calculation unit 301-1 to the absolute difference value calculation unit 301-10 to calculate a SAD value. This SAD value is, for example, a SAD value calculated for one line when the standard block is at the leftmost end of the standard frame, like in the image pa1 in FIG. 3, the image pa12 in FIG. 3, the image pa100 in FIG. 3, the image pa111 in FIG. 4, the image pa122 in FIG. 4, the image pa210 in FIG. 4, the image pa1101 in FIG. 5, the image pa1112 in FIG. 5, the image pa1200 in FIG. 5, or the like.

Similarly, for example, the horizontal addition unit 302-2 sums the absolute difference values output by the absolute difference value calculation units 301 from the absolute difference value calculation unit 301-11 to the absolute difference value calculation unit 301-20 to calculate a SAD value. This SAD value is, for example, a SAD value calculated for one line when the standard block is at a position shifted to the right by one pixel from a left end in the standard frame, like in the image pa2 in FIG. 3, the image pa13 in FIG. 3, the image Pa101 in FIG. 3, the image Pa112 in FIG. 4, the image Pa123 in FIG. 4, the image pa211 in FIG. 4, the image Pa1102 in FIG. 5, the image Pa1113 in FIG. 5, the image pa1201 in FIG. 5, or the like.

Similarly, for example, the horizontal addition unit 302-11 sums the absolute difference values output by the absolute difference value calculation units 301 from the absolute difference value calculation unit 301-101 to the absolute difference value calculation unit 301-110 to calculate a SAD value. This SAD value is, for example, a SAD value calculated for one line when the standard block is at the rightmost end of the standard frame, like in the image pa11 in FIG. 3, the image pa22 in FIG. 3, the image pa110 in FIG. 3, the image pa121 in FIG. 4, the image pa132 in FIG. 4, the image pa220 in FIG. 4, the image pa1111 in FIG. 5, the image pa1122 in FIG. 5, the image pa1201 in FIG. 5, or the like.

The vertical addition units 303 (303-1, 303-2, . . . , 303-11) acquire the SAD values from the horizontal addition units 302 (302-1, 302-2, . . . , 302-11), respectively, and add the acquired SAD values to the respective SAD values stored in the holding units 304 (304-1, 304-2, . . . , 304-11) to be described below. The vertical addition units 303 (303-1, 303-2, . . . , 303-11) overwrite and update the respective SAD values stored in the holding units 304 (304-1, 304-2, . . . , 304-11) with the SAD values after the addition.

For example, the vertical addition unit 303-1 acquires the SAD value from the horizontal addition unit 302-1, and adds the acquired SAD value to the SAD value stored in the holding unit 304-1 to be described below. The vertical addition unit 303-1 overwrites and updates the SAD value stored in the holding unit 304-1 with the SAD value after the addition.

Similarly, for example, the vertical addition unit 303-2 acquires the SAD value from the horizontal addition unit 302-2, and adds the acquired SAD value to the SAD value stored in the holding unit 304-2 to be described below. The vertical addition unit 303-2 overwrites and updates the SAD value stored in the holding unit 304-2 with the SAD value after the addition.

Similarly, for example, the vertical addition unit 303-11 acquires the SAD value from the horizontal addition unit 302-11, and adds the acquired SAD value to the SAD value stored in the holding unit 304-11 to be described below. The vertical addition unit 303-11 overwrites and updates the SAD value stored in the holding unit 304-11 with the SAD value after the addition.

The holding units 304 (304-1, 304-2, . . . , 304-11) store the SAD values, respectively. The holding units 304 (304-1, 304-2, . . . , 304-11) function as temporary storage areas in a process of calculating the SAD value between a certain standard block and the reference block.

When the SAD value has been input from the vertical addition units 303 (303-1, 303-2, . . . , 303-11) ten times (that is, when the SAD value has first been input and then the SAD value has been overwritten or updated nine times), the holding units 304 (304-1, 304-2, . . . , 304-11) output the SAD value to the sorting unit 40 at that point in time. The holding units 304 (304-1, 304-2, . . . , 304-11) initialize the stored SAD value (set the value to zero).

For example, the holding unit 304-1 determines that the SAD calculation between the standard block and the reference block including 10 lines (rows) has been completed when the SAD value has been input ten times from the vertical addition unit 303-1, and outputs a result of the SAD calculation to the sorting unit 40. The holding unit 304-1 initializes the stored SAD value (sets the value to 0).

The standard block that is a target for which the holding unit 304-1 calculates the SAD value is, for example, a standard block when the standard block is located at the leftmost end of the standard frame, like in the image pa1 in FIG. 3, the image pa12 in FIG. 3, the image pa100 in FIG. 3, the image pa1111 in FIG. 4, the image pa122 in FIG. 4, the image pa210 in FIG. 4, the image pa1101 in FIG. 5, the image pa1112 in FIG. 5, the image pa1200 in FIG. 5, or the like.

Similarly, for example, the holding unit 304-2 determines that the SAD calculation between the standard block and the reference block including 10 lines (rows) has been completed when the SAD value has been input ten times from the vertical addition unit 303-2, and outputs a result of the SAD calculation to the sorting unit 40. The holding unit 304-2 initializes the stored SAD value (sets the value to 0).

The standard block that is a target for which the holding unit 304-2 calculates the SAD value is, for example, a standard block when the standard block is at a position shifted to the right by one pixel from a left end in the standard frame, like in the image pa2 in FIG. 3, the image pa13 in FIG. 3, the image Pa101 in FIG. 3, the image Pa112 in FIG. 4, the image Pa123 in FIG. 4, the image pa211 in FIG. 4, the image Pa1102 in FIG. 5, the image Pa1113 in FIG. 5, the image pa1201 in FIG. 5, or the like.

Similarly, for example, the holding unit 304-11 determines that the SAD calculation between the standard block and the reference block including 10 lines (rows) has been completed when the SAD value has been input ten times from the vertical addition unit 303-11, and outputs a result of the SAD calculation to the sorting unit 40. The holding unit 304-11 initializes the stored SAD value (sets the value to 0).

The standard block that is a target for which the holding unit 304-11 calculates the SAD value is, for example, a standard block when the standard block is located at the rightmost end of the standard frame, like in the image pa11 in FIG. 3, the image pa22 in FIG. 3, the image pa110 in FIG. 3, the image pa121 in FIG. 4, the image pa132 in FIG. 4, the image pa220 in FIG. 4, the image pa1111 in FIG. 5, the image pa1122 in FIG. 5, the image pa1201 in FIG. 5, or the like.

Thus, the correlation calculation unit 30 of the calculation device 1 according to the first embodiment can output results of SAD calculation between 11 standard blocks and the reference block on the basis of the ten inputs of the luminance value data from the standard block data storage unit 10 and the reference block data storage unit 20.

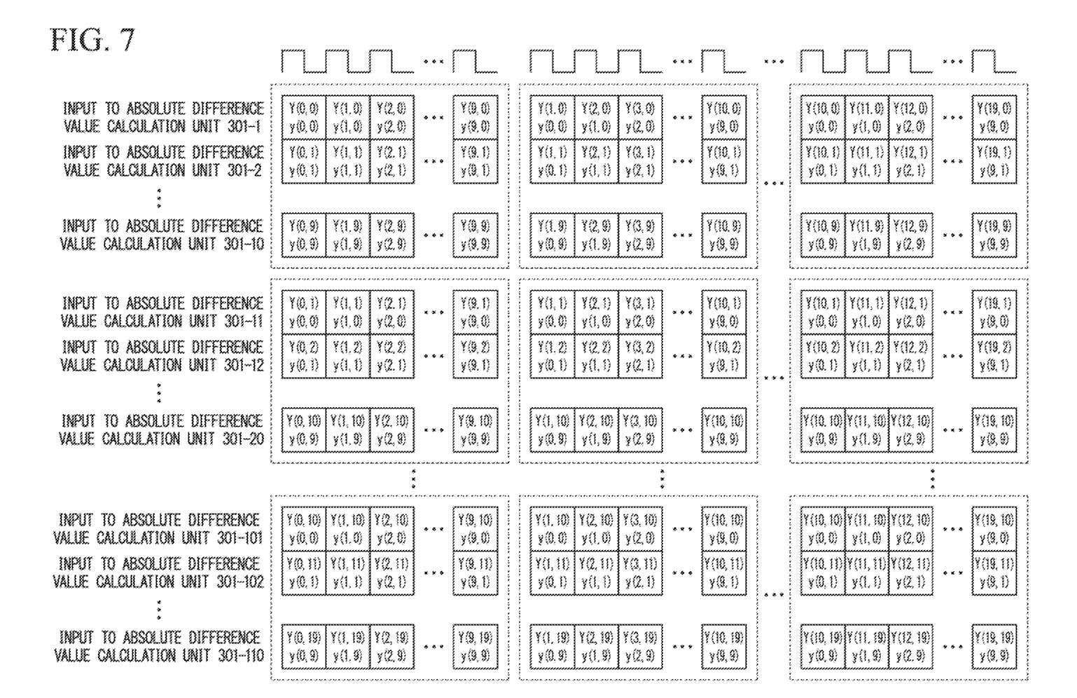

FIG. 7 is a timing chart illustrating an example of a timing at which luminance value data is input to an absolute difference value calculation unit 301 of a calculation device 1 according to the first embodiment of the present invention.

As illustrated, luminance value data Y(0,0) and y(0,0) are input to the absolute difference value calculation unit 301-1, the luminance value data Y(0, 1) and y(0, 1) are input to the absolute difference value calculation unit 301-2, . . . , and the luminance value data Y(0, 19) and y(0, 9) are input to the absolute difference value calculation unit 301-110 at the same timing.

As illustrated, for example, Y(0,0), which is a luminance value of one pixel of the standard block, is first input to the absolute difference value calculation unit 301-1. Here, “(0.0)” indicates coordinates in the standard block. “(0,0)” indicates coordinates of a position after movement by 0 pixels in the vertical direction and 0 pixels in the horizontal direction from the top leftmost pixel in the standard block.

That is, Y(0,0) is data indicating the luminance value of the pixel of the top leftmost pixel in the standard block.

Similarly, for example, y(0,0), which is a luminance value of one pixel of the reference block, is first input to the absolute difference value calculation unit 301-1. Similarly, “(0.0)” indicates coordinates in the reference block. “(0,0)” indicates coordinates of a position after movement by 0 pixels in the vertical direction and 0 pixels in the horizontal direction from the top leftmost pixel in the reference block. That is, y(0,0) is data indicating the luminance value of the pixel of the top leftmost pixel in the reference block.

Similarly, for example, the luminance value data Y(0, 19) is first input to the absolute difference value calculation unit 301-110. “(0, 19)” indicates coordinates of a position after a movement by 0 pixels in a vertical direction and 19 pixels in a horizontal direction from a top leftmost pixel in the reference block. That is, Y(0, 19) is data indicating a luminance value of the top rightmost pixel in the reference block including 20 pixels×20 pixels.

Similarly, for example, the luminance value data Y(0, 9) is first input to the absolute difference value calculation unit 301-110. “(0, 9)” indicates coordinates of a position after a movement by 0 pixels in a vertical direction and 9 pixels in a horizontal direction from a top rightmost pixel in the reference block. That is, Y(0, 9) is data indicating a luminance value of the top rightmost pixel in the reference block including 10 pixels×10 pixels.

As illustrated, at the same timing, the luminance value data Y(19, 0) and y(9, 0) are input to the absolute difference value calculation unit 301-1, the luminance value data Y(19, 1) and y(9, 1) are input to the absolute difference value calculation unit 301-2, . . . and the luminance value data Y(19, 19) and y(9, 9) are input to the absolute difference value calculation unit 301-110, and the input of all of pieces of the luminance value data for performing the SAD calculation between all of 121 standard blocks within the standard frame and the reference block ends.

(Configuration of Sorting Unit)

Next, a configuration of the sorting unit 40 will be described with reference to the drawings.

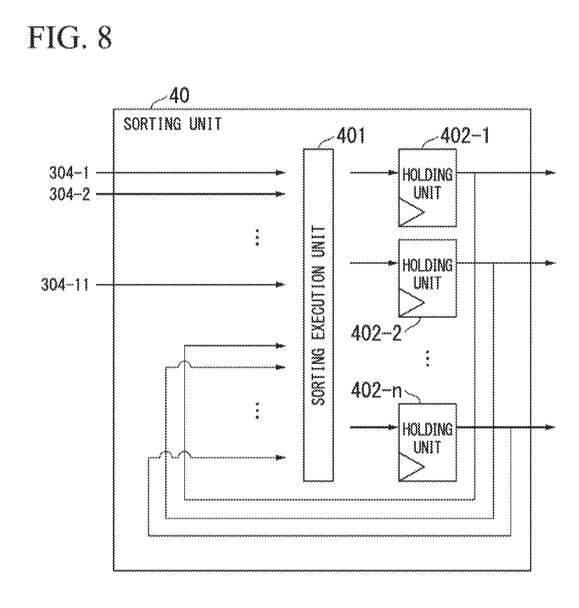

FIG. 8 is a diagram illustrating an example of a configuration of the sorting unit 40 of the calculation device 1 according to the first embodiment of the present invention.

As illustrated, the sorting unit 40 includes a sorting execution unit 401, and n holding units 402 (402-1, 402-2, . . . , 402-n).

The sorting execution unit 401 acquires data indicating SAD values of 11 respective standard blocks from the 11 holding units 304 (304-1, 304-2, . . . , 304-11) of the correlation calculation unit 30 at the same timing. The sorting execution unit 401 sorts the acquired SAD values in an ascending order of values (that is, a descending order of correlation). The sorting execution unit 401 outputs the top n pieces of data (for example, top 10 when n=10) among the sorted SAD values to the respective holding units 402 (402-1 and 402-2, . . . , 402-n). The sorting execution unit 401 outputs the smallest SAD value among the acquired SAD values to the holding unit 402-1, the second smallest SAD value to the holding unit 402-2, . . . , and the n-th smallest SAD value to the holding unit 402-n.

The holding units 402 (402-1, 402-2, . . . , 402-n) store the SAD values, respectively. The holding units 402 (402-1, 402-2, . . . , 402-n) function as temporary storage areas in a process of calculating the SAD values between the respective standard blocks and the reference block. The holding units 402 (402-1, 402-2, . . . , 402-n) temporarily store the top n SAD values from the smaller SAD value calculated at respective points in time in the process of sequentially calculating the SAD values between the respective standard blocks and the reference block.

Next, the sorting execution unit 401 acquires the data indicating the SAD values for the 11 standard blocks from the 11 holding units 304 (304-1, 304-2, . . . , 304-11) of the correlation calculation unit 30 again at the same timing.

The sorting execution unit 401 sorts (11+u) SAD values obtained by summing the 11 acquired SAD values and the n SAD values stored in the holding units 402 (402-1, 402-2, . . . , 402-n) in an ascending order of values (that is, a descending order of correlation).

The sorting execution unit 401 outputs the top n pieces of data (for example, the top 10 when n=10) among the sorted SAD values to the respective holding units 402 (402-1, 402-2, . . . , 402-n) to overwrite and update the data of the SAD values stored in the respective holding units 402 (402-1 and 402-2, . . . , 402-n) with the top n pieces of data.

When the respective holding units 402 (402-1, 402-2, . . . , 402-n) acquire data of the SAD values from the sorting execution unit 401 11 times (that is, when the sorting execution unit 401 first stores the SAD value in the respective holding units 402 (402-1, 402-2, . . . , 402-n) and then overwrites and updates the SAD value ten times), the respective holding units 402 (402-1, 402-2, . . . , 402-n) determine that the SAD calculation between the reference block and all of the 121 standard blocks within the standard frame ends, and output the data indicating the SAD values respectively stored in the n holding units 402 (402-1, 402-2, . . . , 402-n) at that point in time outside of the calculation device 1.

That is, the sorting unit 40 outputs data indicating the top n SAD values having higher correlation with the reference block (that is, having a small SAD value) in the 121 standard blocks within the standard frame to the outside of the calculation device 1.

The number of holding units 402 (402-1, 402-2, . . . , 402-n) varies depending on a purpose of the output of the SAD value. For example, the number of holding units 402 (402-1, 402-2, . . . , 402-n) may be only one (that is, n=1) as long as outputting only one portion of the image of the standard frame that most approximates to the image of the reference block is a purpose.

The basic portions of the configuration of the calculation device 1 according to the first embodiment of the present invention have been described. However, in the above description, a portion of a configuration for reducing power consumption that is an object of the present invention is not mentioned.

With only the above-described configuration, the calculation device 1 executes all of calculations of the absolute difference values of the luminance values of the respective pixels with respect to the SAD calculation between all the standard blocks within the standard frame and the reference block. That is, the calculations of the absolute difference values of the luminance values of a total of 110 pixels are performed in one process, and this calculation is repeatedly performed 110 times (when the standard frame includes 20 pixels×20 pixels and the reference block includes 10 pixels×10 pixels). Therefore, in the calculation device 1, an operation of the calculation circuit occurs with a total of 12100 absolute difference value calculations. Since power consumption occurs with the operation of this circuit, decreasing the number of operations of the calculation circuit leads to a reduction in power consumption.

Hereinafter, a configuration for reducing the power consumption of the calculation device 1 will be described.

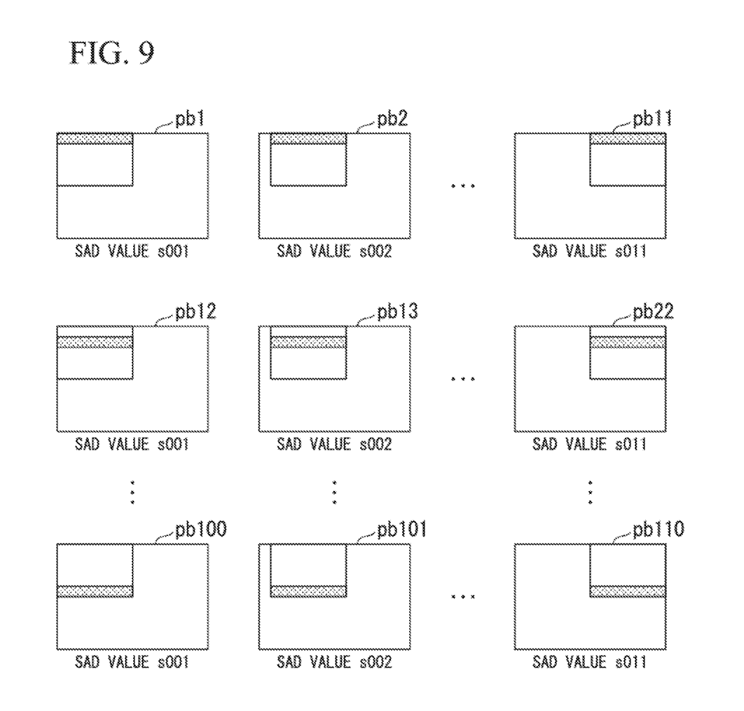

FIGS. 9, 10, and 11 are schematic diagrams illustrating examples of the correlation calculation in the calculation device 1 according to the first embodiment of the present invention.

Since basic description of the standard frame, the standard block, and the reference block illustrated in FIGS. 9, 10, and 11 is the same as the content described with reference to FIGS. 3, 4, and 5, the description thereof will be omitted.

As illustrated in FIG. 9, the calculation device 1 performs the SAD calculation with the reference blocks sequentially from the standard block located on the uppermost side of the standard frame.

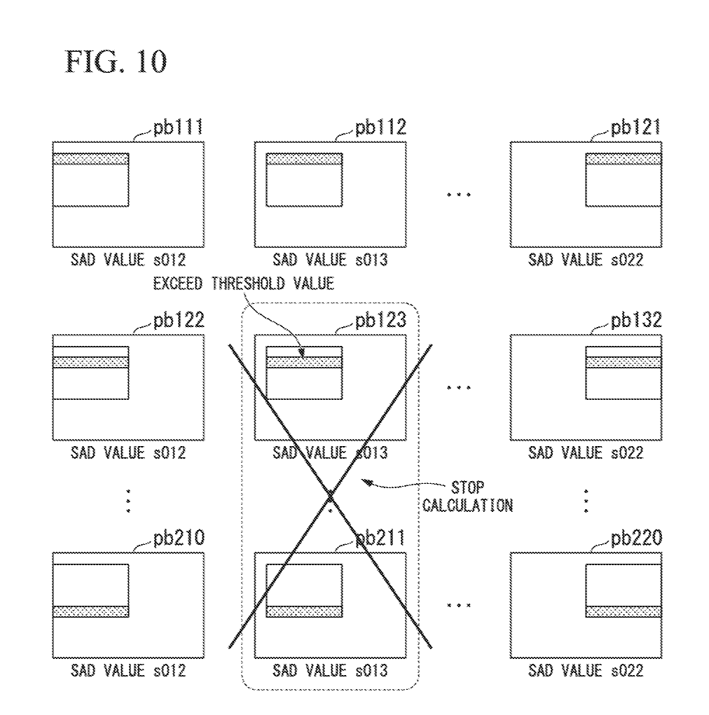

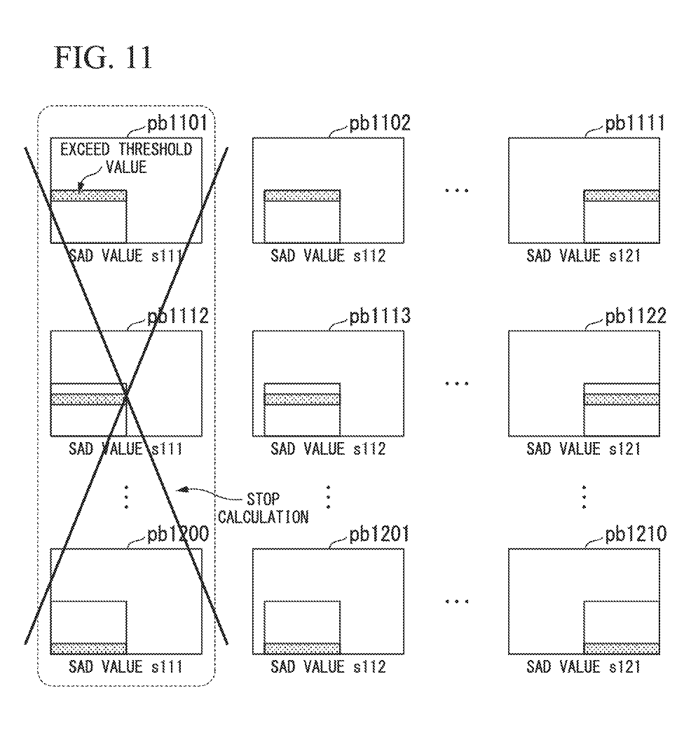

For example, when the SAD value during the calculation exceeds the correlation threshold value to be described below before the calculation of the SAD values of the standard blocks is completed (that is, before the calculation of the SAD values of the standard blocks shown in an image pb211 of FIG. 10 and an image pb1200 of FIG. 11 is completed), like standard blocks shown in an image pb123 of FIG. 10 and an image pb1101 of FIG. 11, the calculation device 1 stops calculation of subsequent SAD values of the standard blocks and the process of adding the SAD values.

Here, the correlation threshold value is, for example, the SAD value stored in the holding unit 402-n of the sorting unit 40 described above. That is, the value of the holding unit 402-n that stores the greatest SAD value (that is, the SAD value having the lowest degree of correlation among the stored SAD values) among the SAD values stored in the holding units 402 (402-1, 402-2, . . . , 402-n) is the correlation threshold value.

Since the SAD calculation is calculation that continuously adds the absolute difference values, the SAD value does not decrease during the SAD calculation. When the SAD value during the calculation has exceeded the SAD value (the correlation threshold value) stored in the holding unit 402-n, the SAD value is necessarily greater than the SAD value (the correlation threshold value) lastly stored in the holding unit 402-n. Therefore, in the process of sorting the SAD values in the sorting unit 40, the last SAD value (for example, the SAD value s013 in FIG. 10 and a SAD value s111 in FIG. 11) does not belong to the top n from a smaller SAD value n. Thus, the last SAD value is not stored in the holding units 402 (402-1, 402-2, . . . , 402-n), but is a SAD value that is necessarily discarded.

Thus, when the SAD value during the calculation has exceeded the SAD value (the correlation threshold value) stored in the holding unit 402-n, a process of calculating the subsequent SAD value in the standard block during the SAD calculation becomes an unnecessary calculation process. Therefore, when the SAD value during the calculation has exceeded the correlation threshold value, the calculation device 1 stops calculation of subsequent SAD values in the standard block.

(Detailed Configuration of Calculation Device 1)

Hereinafter, a detailed configuration of the calculation device 1 will be described with reference to the drawings.

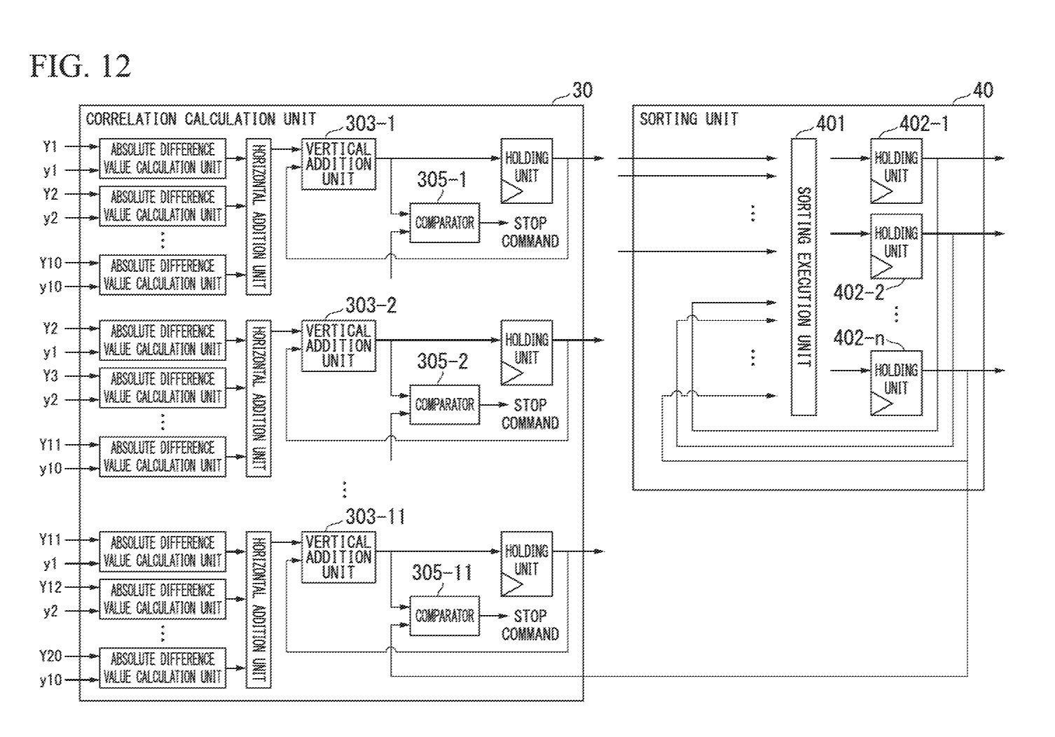

FIG. 12 is a diagram illustrating an example of a configuration of the correlation calculation unit 30 and the sorting unit 40 of the calculation device 1 according to the first embodiment of the present invention.

As illustrated, the correlation calculation unit 30 illustrated in FIG. 12 includes 11 comparators 305 (305-1, 305-2, . . . , 305-n). The SAD value (a correlation threshold value) stored in the holding unit 402-n of the sorting unit 40 is input to each of the 11 comparators.

The comparators 305 (305-1, 305-2, . . . , 305-n) compare the SAD value output by the vertical addition units 303 (303-1, 303-2, . . . , 303-11) with the correlation threshold value, and output a signal indicating a stop command when the SAD value is a value exceeding the correlation threshold value.

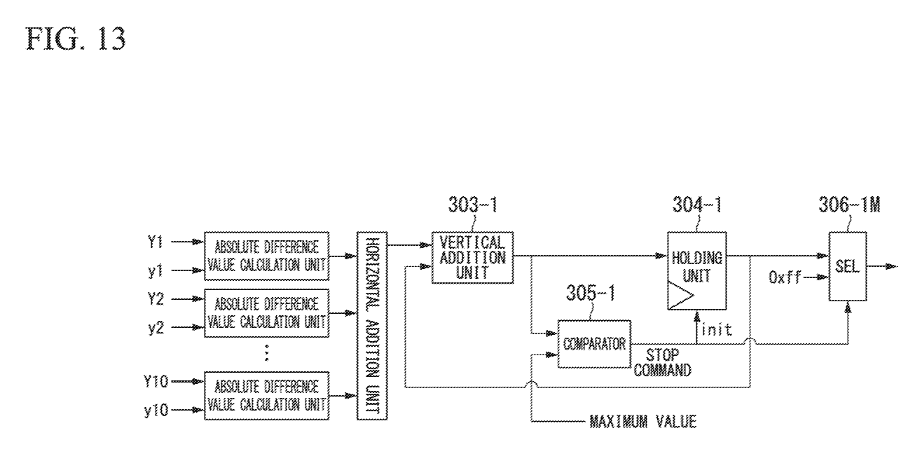

FIG. 13 is a diagram illustrating an example of a calculation stop operation of a correlation calculation unit 30 of the calculation device 1 according to the first embodiment of the present invention.

A range illustrated in FIG. 13 is a range of a portion of the correlation calculation unit 30 of the calculation device 1.

The correlation calculation unit 30 includes 11 selectors 306 (306-1M. 306-2M, . . . , 306-11M). The selector 306-1M, which is one of the selectors 306, is illustrated in FIG. 13.

The comparators 305 (305-1, 305-2, . . . , 305-n) compare the SAD values output by the vertical addition units 303 (303-1, 303-2, . . . , 303-11) with the correlation threshold value. When the SAD value is a value exceeding the correlation threshold value, the comparator 305 outputs a signal indicating a stop command to stop an operating clock (not illustrated) that is supplied to a calculation circuit (for example, a flip flop). Further, the comparators 305 (305-1, 305-2, . . . , 305-n) output the signal indicating a stop command to the selector 306. When the selector 306 has acquired the signal indicating a stop command from the comparator 305, the selector 306 fixes the SAD value to be output to the sorting unit 40 to a maximum value (for example, a value such as 0 xff) irrespective of the value when the SAD value has been acquired from the holding unit 304. Thus, by stopping the operation of the calculation circuit for SAD values, the calculation device 1 can minimize power consumption of the SAD calculation circuit.

(Operation of Calculation Device)

Next, a flow of an operation of the calculation device 1 will be described.

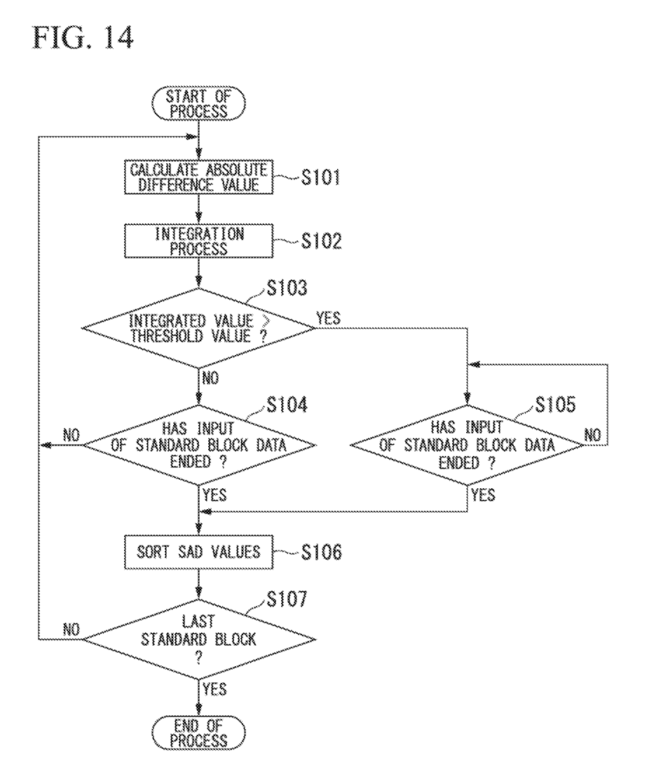

FIG. 14 is a flowchart illustrating an example of an operation of the calculation device 1 according to the embodiment of the present invention.

This flowchart is started when the calculation device 1 starts the SAD calculation between the standard frame and the reference frame.

(Step S101) The absolute difference value calculation units 301 (301-1, 301-2, . . . 301-110) of the correlation calculation unit 30 sequentially calculate the absolute difference values on the basis of the luminance value acquired from the standard block data storage unit 10 and the luminance value acquired from the reference block data storage unit 20. Then, the process proceeds to step S102.

(Step S102) The horizontal addition units 302 (302-1, 302-2, . . . , 302-11) of the correlation calculation unit 30 sequentially add the absolute difference values acquired from the absolute difference value calculation units 301 (301-1, 301-2, . . . , 301-110) to calculate the SAD value for one line in the standard block. The vertical addition unit 303 of the correlation calculation unit 30 sequentially adds the SAD values acquired from the horizontal addition units 302 (302-1, 302-2, . . . , 302-11) to calculate the SAD values for all the standard blocks. The holding unit 304 of the correlation calculation unit 30 stores the SAD value acquired from the vertical addition unit 303. The holding unit 304 of the correlation calculation unit 30 outputs the stored SAD value to the sorting unit 40. Then, the process proceeds to step S103.

(Step S103) The comparators 305 (305-1, 305-2, . . . , 305-n) of the correlation calculation unit 30 compare the SAD value acquired from the vertical addition unit 303 with the correlation threshold value acquired from the sorting unit 40. When the SAD value acquired from the vertical addition unit 303 exceeds the correlation threshold value, the comparators 305 (305-1, 305-2, . . . , 305-n) stop the operation of the calculation circuit for SAD values and then the process proceeds to step S105. When the SAD value acquired from the vertical addition unit 303 does not exceed the correlation threshold value, the process proceeds to step S104.

(Step S104) When the input of the data of the standard block in the calculation ends, the process proceeds to step S106. Otherwise, the process returns to step S101.

(Step S105) When the input of the data of the standard block in the calculation ends, the process proceeds to step S106. Otherwise, the process returns to step S105.

(Step S106) The sorting execution unit 401 of the sorting unit 40 sorts the SAD values including the SAD values acquired from the correlation calculation unit 30 and the SAD values stored in the holding units 402 (402-1, 402-2, . . . , 402-n) in an ascending order. Thereafter, the process proceeds to step S107.

(Step S107) When the calculation of the SAD values up to the last standard block has been completed, the process of this flowchart ends. Otherwise, the process returns to step S101.

As described above, the calculation device 1 according to the first embodiment of the present invention includes the sorting unit 40 that sorts the plurality of correlation values (SAD values) calculated by the respective horizontal addition units 302 (302-1, 302-2, . . . , 302-11) and the respective vertical addition units 303 of the correlation calculation unit 30 in a descending order of correlation, and holds a result of the sorting. The sorting unit 40 outputs the correlation threshold value based on the held correlation value to the respective comparators 305 (305-1, 305-2, . . . , 305-n) of the correlation calculation unit 30. The respective comparators 305 (305-1, 305-2, . . . , 305-n) perform the correlation calculation stop process of comparing the acquired correlation threshold value with the plurality of respective calculated correlation values, and stopping the operation of the correlation calculation unit 30 when the correlation value is lower than the correlation threshold value.

Thus, the calculation device 1 according to the first embodiment can reduce power consumption of the calculation circuit in the correlation calculation.

### Second Embodiment

Next, a second embodiment of the present invention will be described with reference to the drawings.

Since a basic configuration of a calculation device 1 according to the second embodiment is the same as the basic configuration of the calculation device 1 according to the first embodiment, description of portions having the same configuration will be omitted.

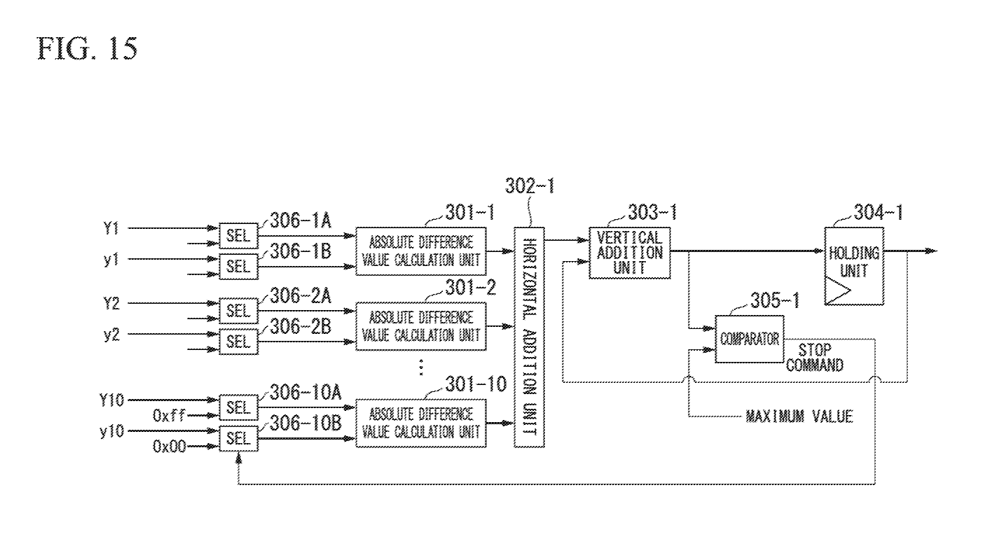

FIG. 15 is a diagram illustrating an example of a calculation stop operation of a correlation calculation unit 30 of the calculation device 1 according to the second embodiment of the present invention.

As illustrated, the calculation device 1 according to the second embodiment includes 220 selectors 306 (306-1A, 306-2A, . . . , 306-110A, and 306-1B, 306-2B, . . . , 306-110B). Among them, only 20 selectors 306 (306-1A, 306-2A, . . . , 306-10A, and 306-1B, 306-2B, . . . , 306-10B) are illustrated in FIG. 15.

The data output from the standard block data storage unit 10 and the reference block data storage unit 20 is input to the respective absolute difference value calculation units 301 (301-1, 301-2, . . . , 301-110) of the correlation calculation unit 30 via the selectors 306 (306-1A, 306-2A, . . . , 306-110A, and 306-1B, 306-2B, . . . , 306-110B). The selectors 306 (306-1A, 306-2A, . . . , 306-110A) are provided between the standard block data storage unit 10 and the 110 absolute difference value calculation units 301, and the selectors 306 (306-1B, 306-2B, . . . , 306-110B) are provided between the reference block data storage unit 20 and the 110 absolute difference value calculation units 301.

As illustrated, the comparators 305 (305-1, 305-2 . . . , 305-n) of the correlation calculation unit 30 compare the SAD values calculated by the vertical addition units 303 (303-1 and 303-2, . . . , 303-11) with the correlation threshold value acquired from the sorting unit 40, and output a signal indicating a stop command when the SAD value has exceeded the correlation threshold value. In the second embodiment, the signal indicating a stop command is output to all of 220 selectors 306 (306-1A. 306-2A, . . . , 306-110A, and 306-1B, 306-2B, . . . , 306-110B).

When the selectors 306 (306-1A, 306-2A, . . . , 306-110A) have acquired the signal indicating a stop command from the comparators 305 (305-1, 305-2, . . . , 305-11), the selectors 306 (306-1A, 306-2A, . . . , 306-110A) output a value (for example, 0xff) indicating a maximum value to the absolute difference value calculation units 301 (301-1, 301-2, . . . , 301-110) irrespective of the value of the luminance value acquired from the standard block data storage unit 10.

Further, when the selectors 306 (306-1B, 306-2B, . . . , 306-110B) have acquired the signal indicating a stop command from the comparators 305 (305-1, 305-2, . . . , 305-11), the selectors 306 (306-1B, 306-2B, . . . , 306-110B) output a value (for example, 0x00) indicating a minimum value to the absolute difference value calculation units 301 (301-1, 301-2, . . . , 301-110) irrespective of the value of the luminance value acquired from the reference block data storage unit 20.

That is, in the correlation calculation unit 30 of the calculation device 1 according to the second embodiment, when the signal indicating a stop command is output from the comparators 305 (305-1, 305-2, . . . , 305-11), data of two fixed values including the value (for example, 0xff (data indicating white)) indicating the maximum value and the value (for example, 0x00 (data indicating black)) indicating the minimum value is input to the absolute difference value calculation units 301 (301-1, 301-2, . . . , 301-110).

Accordingly, the absolute difference values calculated by the respective absolute difference value calculation units 301 (301-1, 301-2, . . . , 301-110) are fixed to a maximum value that can be acquired. By fixing an input value, data transition in respective functional blocks (calculation circuits) such as the absolute difference value calculation units 301 (301-1, 301-2, . . . , 301-110), the comparators 305 (305-1, 305-2, . . . , 305-11), and the sorting unit 40 is stopped. Power consumption of each calculation circuit is reduced due to stopping of the data transition.

As described above, the calculation device 1 according to the second embodiment of the present invention can reduce power consumption of the calculation circuit in the correlation calculation.

### Third Embodiment

Next, a third embodiment of the present invention will be described with reference to the drawings.

Since a basic configuration of a calculation device 1 according to the third embodiment is the same as the basic configuration of the calculation device 1 according to the first embodiment, description of portions having the same configuration will be omitted.

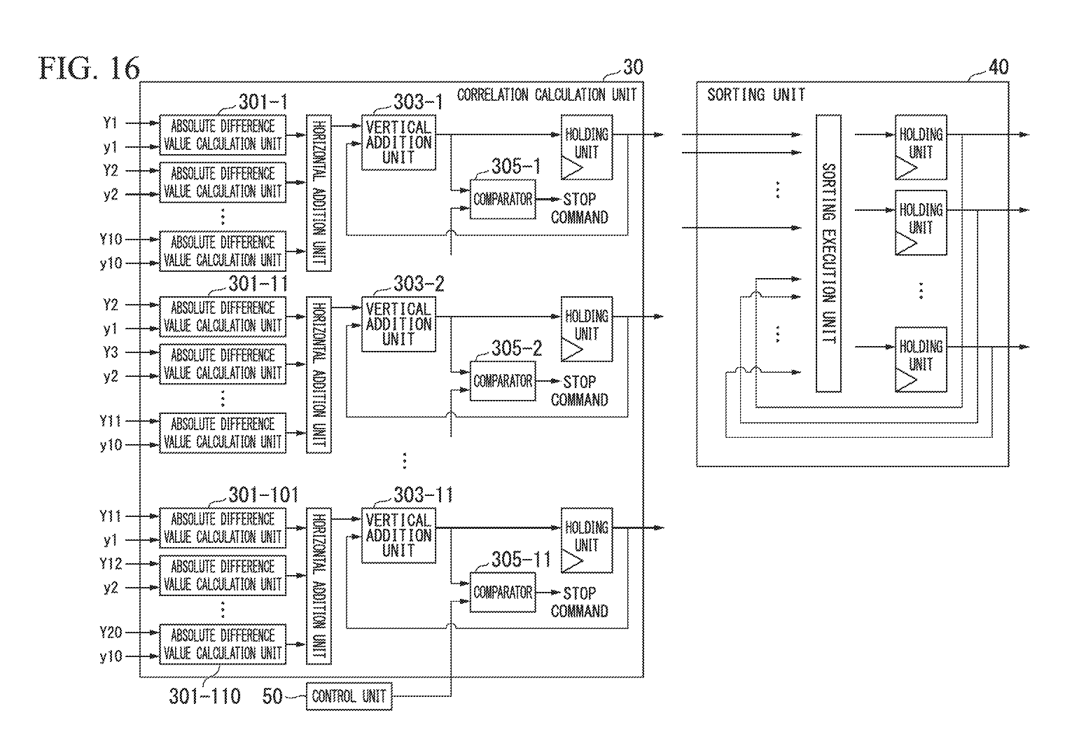

FIG. 16 is a diagram illustrating an example of a calculation stop operation of a correlation calculation unit 30 of the calculation device 1 according to the third embodiment of the present invention.

As illustrated, the calculation device 1 according to the third embodiment includes a control unit 50. The control unit 50 can set the correlation threshold value using any means and output the set correlation threshold value to the respective comparators 305 (305-1, 305-2, . . . , 305-11). The means may be, for example, means for causing a constant value to be set as the correlation threshold value in advance at the time of initial setting. The control unit 50 includes, for example, a central processing unit (CPU).

As illustrated, the comparators 305 (305-1, 305-2, . . . , 305-11) of the correlation calculation unit 30 compare the SAD values calculated by the vertical addition units 303 (303-1, 303-2, . . . , 303-11) with the correlation threshold value acquired from the control unit 50, and output a signal indicating a stop command when the SAD value has exceeded the correlation threshold value.

By outputting the signal indicating a stop command from the comparators 305 (305-1, 305-2, . . . , 305-11), for example, an operation clock to be supplied to a calculation circuit (for example, a flip flop) may be stopped such that power consumption of the calculation circuit can be reduced, as in the calculation device 1 in the first embodiment.

Further, for example, the power consumption of the calculation circuit may be reduced by fixing the data to be input to the respective absolute difference value calculation units 301 (301-1, 301-2, . . . , 301-110), as in the calculation device 1 in the second embodiment.

As described above, the calculation device 1 according to the third embodiment of the present invention can reduce power consumption of the calculation circuit in the correlation calculation.

While the preferred embodiments of the present invention have been described above, the present invention is not limited to these embodiments. Additions, omissions, substitutions, and other modifications to the configuration can be made without departing from the spirit of the present invention.

Further, the present invention is not limited by the foregoing description, and is limited by only the appended claims.

A part or all of the calculation device 1 in the above-described embodiment may be realized by a computer. In this case, a part or all of the calculation device 1 may be realized by recording a program for realizing control functions thereof on a computer-readable recording medium, loading the program recorded on the recording medium into a computer system, and executing the program.

Here, the “computer system” is a computer system built into the calculation device 1 and is assumed to include an OS or hardware such as a peripheral device. Further, the “computer-readable recording medium” refers to a portable medium such as a flexible disk, a magneto-optical disc, a ROM, or a CD-ROM, or a storage device such as a hard disk embedded in the computer system.

Further, the “computer-readable recording medium” includes a recording medium that dynamically holds a program for a short period of time, such as a communication line when the program is transmitted over a network such as the Internet or a communication line such as a telephone line or a recording medium that holds a program for a certain period of time, such as a volatile memory inside a computer system including a server and a client in such a case. Further, the program may be a program for realizing some of the above-described functions or may be a program capable of realizing the above-described functions in combination with a program previously stored in the computer system.

Further, the calculation device 1 in the above-described embodiment may be realized as an integrated circuit such as a large scale integration (LSI). Each functional block of the calculation device 1 may be individually configured as a processor, or a portion or all thereof may be integrated and configured as a processor. Further, an integrated circuit scheme is not limited to an LSI and may be realized as a dedicated circuit or a general-purpose processor. Further, in a case in which an integrated circuit technology with which an LSI is replaced appears with the advance of semiconductor technology, an integrated circuit according to this technology may be used.

What is claimed is:

1. A calculation device that divides a standard frame into a plurality of standard blocks, sets a reference block corresponding to the standard frame in a reference frame, and performs correlation calculation between the standard block and the reference block, the calculation device comprising:
a standard block data storage unit that stores data of the standard block;
a reference block data storage unit that stores data of the reference block;
a plurality of correlation calculation units that receive respective predetermined correlation threshold values and simultaneously calculate correlation values at a plurality of different positions using data of the standard block and data of the reference block; and
a sorting unit that sorts the plurality of correlation values calculated by the correlation calculation unit in a descending order of correlation, holds a result of the sorting, and outputs the correlation threshold values,
wherein the calculation device compares the respective input correlation threshold values with the plurality of correlation values calculated by the plurality of correlation calculation units, and performs a correlation calculation stop process of stopping an operation of the correlation calculation unit when the correlation value has a lower correlation than the correlation threshold value.

2. The calculation device according to claim 1,
wherein the correlation threshold value is a correlation value having the highest correlation among the correlation values after sorting held in the sorting unit.

3. The calculation device according to claim 1,
wherein the correlation calculation stop process is a process of stopping an operation of the correlation calculation unit by stopping an operation clock of the correlation calculation unit.

4. The calculation device according to claim 1,
wherein the correlation calculation stop process is a process of stopping an operation of the correlation calculation unit by setting one of pieces of data to be input to the correlation calculation unit to a maximum value and the other to a minimum value.

5. The calculation device according to claim 1,
wherein the correlation calculation stop process is a process that ends when correlation calculation between the next standard block and the reference block is started.

6. A calculation method of dividing a standard frame into a plurality of standard blocks, setting a reference block corresponding to the standard frame in a reference frame, and performing correlation calculation between the standard block and the reference block, the calculation method comprising:
a standard block data storage step of storing data of the standard block;
a reference block data storage step of storing data of the reference block;
a plurality of correlation calculation steps of receiving respective predetermined correlation threshold values and simultaneously calculating correlation values at a plurality of different positions using data of the standard block and data of the reference block; and
a sorting step of sorting the plurality of correlation values calculated in the correlation calculation step in a descending order of correlation, holding a result of the sorting, and outputting the correlation threshold values,
wherein the method includes a correlation calculation stop step of comparing the respective input correlation threshold values with the plurality of correlation values respectively calculated in the plurality of correlation calculation steps, and stopping an operation in the correlation calculation step when the correlation value has a lower correlation than the correlation threshold value.

7. A non-transitory computer-readable computer medium storing a program that causes a computer to divide a standard frame into a plurality of standard blocks, set a reference block corresponding to the standard frame in a reference frame, and perform correlation calculation between the standard block and the reference block, the program causing the computer to execute:
a standard block data storage step of storing data of the standard block;
a reference block data storage step of storing data of the reference block;
a plurality of correlation calculation steps of receiving respective predetermined correlation threshold values and simultaneously calculating correlation values at a plurality of different positions using data of the standard block and data of the reference block;
a sorting step of sorting the plurality of correlation values calculated in the correlation calculation step in a descending order of correlation, holding a result of the sorting, and outputting the correlation threshold values; and
a correlation calculation stop step of comparing the respective input correlation threshold values with the plurality of correlation values respectively calculated in the plurality of correlation calculation steps, and stopping an operation in the correlation calculation step when the correlation value has a lower correlation than the correlation threshold value.
